(19) United States
(12) Patent Application Publication
(10) Pub. No.: US 2012/0070113 A1
(43) Pub. Date: Mar. 22, 2012

(54) OPTICAL MODULE AND MANUFACTURING METHOD THEREOF

(76) Inventor: SATORU ISHII, Tokyo (JP)

(21) Appl. No.: 13/223,813

(22) Filed: Sep. 1, 2011

(30) Foreign Application Priority Data
Sep. 22, 2010 (JP) 212478/2010

(51) Int. Cl. G02B 6/125; B23K 1/20; B23P 17/04; G02B 6/13

(52) U.S. Cl. 385/14; 228/164; 29/428

(57) ABSTRACT

An optical module includes a substrate including interferometers and a carrier which is connected to a joining area which is a part area of a bottom surface of the substrate, wherein the bottom surface area corresponding to an area on the substrate which the interferometer occupies is not included in the joining area.

This application is based upon and claims the benefit of priority from Japanese Patent Application No. 2010-212478, filed on Sep. 22, 2010, the disclosure of which are incorporated herein in their entirety by reference.

### TECHNICAL FIELD

The present invention relates to an optical module and a manufacturing method thereof and, in particular, relates to the optical module having interferometers and a manufacturing method thereof.

### BACKGROUND ART

Interferometers using optical waveguides of Planar Lightwave Circuit (PLC), such as the Mach-Zehnder Interferometer (MZI) as shown in FIG. 2 and the Multi-Mode Interferometer (MMI) as shown in FIG. 3, are utilized in various optical functional elements. In addition, in recent years, according to dramatic increase of network traffics, development of optical transmission technologies for 100 Gb/s level is extensively advancing, and an optical digital coherent technology using multilevel coding technologies such as Dual-polarization Quadrature phase shift keying (DP-QPSK) is attracted with great importance. Further, for the optical digital coherent technology, highly accurate interferometers such as hybrid interferometers and Polarization Beam Splitters (PBS) or the like are used.

Fluctuations of refractive index affect interference characteristics of the above mentioned interferometers. For example, in case of the MZI shown in FIG. 2, when a balance of the refractive index between an optical splitter 108a and two arm waveguides 110a connected with an optical coupler 109a is lost, the interference characteristics significantly fluctuate. A stress added to a substrate of PLC is considered as one of factors that deteriorate the balance of the refractive index. The stress is mainly caused when sticking the substrate of PLC on a carrier which mounts it using solder or adhesive in order to integrate the substrate of PLC in a module package. The stress added to the substrate at this time tends to seriously influence the interferometers formed on the substrate of PLC.

For example, as shown in FIG. 4, for a hybrid interferometer comprising the MZI and has an optical splitter 108b and an optical coupler 109b, the output phase between ports has difference of ninety degrees in phase angles. Suppose a stress is added uniformly to an entire structure of the MZI, it affects only on the difference between two arm waveguide lengths corresponding to amount of λ/4. Because actual difference of these waveguide lengths is within order of submicron, in order for the phase angle to fluctuate by one degree, the fluctuation of refractive index on the order of 10⁻² is required for the both arms. However, in this case, normal fluctuation of refractive index caused by the stress is within on the order of 10⁻⁵. For this reason, when the stress is added uniformly to the entire structure of the MZI, the stress does not cause almost any influence.

However, in practical situation, a non-uniform stress is added on the whole structure of the MZI. For this reason, because amount of the stress which is added to each of two arm waveguides is different, the amount of refractive index fluctuation caused by the stress also takes different value for each of two arm waveguides. A phase angle is specified by a difference of optical length which is given by product of the refractive index and a waveguide length of the two arm waveguides. When the amount of refractive index fluctuation among the two arm waveguides is different, its influence on the phase angle is determined by the total arm waveguide length. In fact, actual arm waveguide length is around several mm. In this case, the fluctuation per one degree of the phase angle is caused by the fluctuation on the order of 10⁻⁶ of the refractive index. Accordingly, in practice, there is a possibility that the phase angle fluctuates by the stress which is added to the structure of the MZI.

In addition, when designing a polarizing beam splitter (PBS) using the MZI as shown in FIG. 5, the refractive index of the entire interferometer, as well as the difference of refractive index between two arm waveguides, must be controlled within on the order of 10⁻⁵. The PBS comprises of an optical splitter 108c, an optical coupler 109c and a birefringence structure 112c.

For these kinds of high accuracy interferometers, even though the interferometers can be produced with high accuracy, when being integrated in a module package or the like, the fluctuations of refractive index by the stress are caused, and as a result, accuracy of the interferometers will be degraded.

The Japanese Patent Application Laid-Open No. 2008-193003 (hereinafter referred to as patent document 1) discloses an optical module comprising an optical element unit which is hybrid-integrated of a PLC substrate having both an optical waveguide and an optical element and a temperature control element for controlling temperature of the optical element unit, wherein the optical element unit and the temperature control element are joined at a part of a bottom surface corresponding to a part other than the optical waveguide of the optical element unit. The optical module has concurrently achieved both relaxation of outside stress-dependency of an optical element characteristic by making a structure so that a strain caused by thermal or mechanical deformation of a temperature control element or a package does not affect to the optical element as a stress, and appropriate control of constant temperature of the optical element.

The Japanese Utility Model Application Laid-Open No. 1992-137305 (hereinafter referred to as patent document 2) discloses a waveguide-type optical device comprising a waveguide substrate of which an optical waveguide is formed in a substrate and a reinforcing member which holds the waveguide substrate, wherein a structure of the waveguide-type optical module has an area which is fixed with a bottom surface of the waveguide substrate of the reinforcing member is smaller than an area of the entire bottom surface of the waveguide substrate. The disclosed optical device can relax a strain which occurs at a time of hardening of adhesive and can stabilize optical waveguide characteristics, because a fixing area of the bottom surface of the waveguide substrate in which the reinforcing member is fixed can be decreased than the entire bottom surface of the waveguide substrate.

However, while the optical module according to the patent document 1 has a structure that a strain caused by thermal or mechanical deformation of a temperature control element and a package do not affect to the optical element as a stress, any stress which affects the substrate having the waveguides including the interferometers is not considered for the optical module. For this reason, when the structure is applied to a substrate having the interferometers, a stress to the interferometers is induced and it is supposed that the accuracy of interferometers will be degraded.

Further, for the optical device according to the patent document 2, a fixing area of the bottom surface of the waveguide substrate in which the reinforcing member is fixed is minimized compared with the entire bottom surface of the waveguide substrate. For this reason, the reinforcing member cannot be tightly glued with the waveguide substrate, and cannot maintain enough mechanical strength which is required for the optical device.

Therefore, the related technologies have a problem that it cannot keep the accuracy of the interferometers in a high level without causing any degradation of mechanical strength of the optical module.

### SUMMARY

An exemplary object of the present invention is to provide an optical module and a manufacturing method thereof utilizing interferometer whose accuracy is maintained at a high level without causing any degradation of mechanical strength of the optical module.

An optical module according to an exemplary aspect of the invention includes a substrate including interferometers and a carrier which is connected to a joining area which is a part area of a bottom surface of the substrate, wherein the bottom surface area corresponding to an area on the substrate which the interferometer occupies is not included in the joining area.

A manufacturing method of the optical module according to an exemplary aspect of the invention includes the steps of forming a joining area and connecting a carrier which mounts the substrate to the joining area which is a part area of a bottom surface of a substrate having the interferometers and does not include other part area of the bottom surface which is corresponding to an area which the interferometer occupies on the substrate.

### BRIEF DESCRIPTION OF THE DRAWINGS

Exemplary features and advantages of the present invention will become apparent from the following detailed descriptions when taken with the accompanying drawings in which:

FIG. 1A shows an exploded perspective diagram of an optical module of a first embodiment of the present invention;

FIG. 1B shows a cross section diagram along 1B-1B line of the exploded perspective diagram of FIG. 1A;

FIG. 1C shows a cross section diagram at not disassembled status of an optical module of a first embodiment of the present invention;

FIG. 2 shows a Mach-Zehnder Interferometer;

FIG. 3 shows a Multi-Mode interferometer;

FIG. 4 shows a hybrid interferometer;

FIG. 5 shows a polarizing beam splitter using the MZI;

FIG. 6 is a cross section diagram showing another example of the optical module of the first embodiment of the present invention;

FIG. 7 is an exploded perspective diagram showing another example of the optical module of the first embodiment of the present invention;

FIG. 8 is an exploded perspective diagram showing another example of the optical module of the first embodiment of the present invention;

FIG. 9 is an exploded perspective diagram showing another example of the optical module of the first embodiment of the present invention;

FIG. 10 is a cross section diagram showing an example of the optical module of the first embodiment of the present invention;

FIG. 11 is a chart showing a variation amount of phase angle of a comparison example of the present invention; and

FIG. 12 is a chart showing a variation amount of phase angle of a detailed description of preferred embodiment of the present invention.

### EXPLANATION OF SYMBOLS

100, 100a, 100b, 100c, 100d and 100e optical module
101, 101a, 101b, 101c and 101e substrate
102, 102a, 102b, 102c and 102e carrier
103, 103a, 103b, 103c and 103e first interferometer
104, 104a, 104b, 104c and 104e second interferometer
105, 105d and 105e first interferometer area
106 and 106e second interferometer area
107, 107a, 107b, 107c, 107d and 107e joining area
108a, 108b and 108c optical splitter
109a, 109b and 109c optical coupler
110a and 110d arm waveguide
111a, 111b and 111c third interferometer area
112c birefringence structure
113 and 113d waveguide
114d MMI

### EXEMPLARY EMBODIMENT

Next, embodiments for carrying out the present invention will be described in detail by referring to the figures.

### First Embodiment

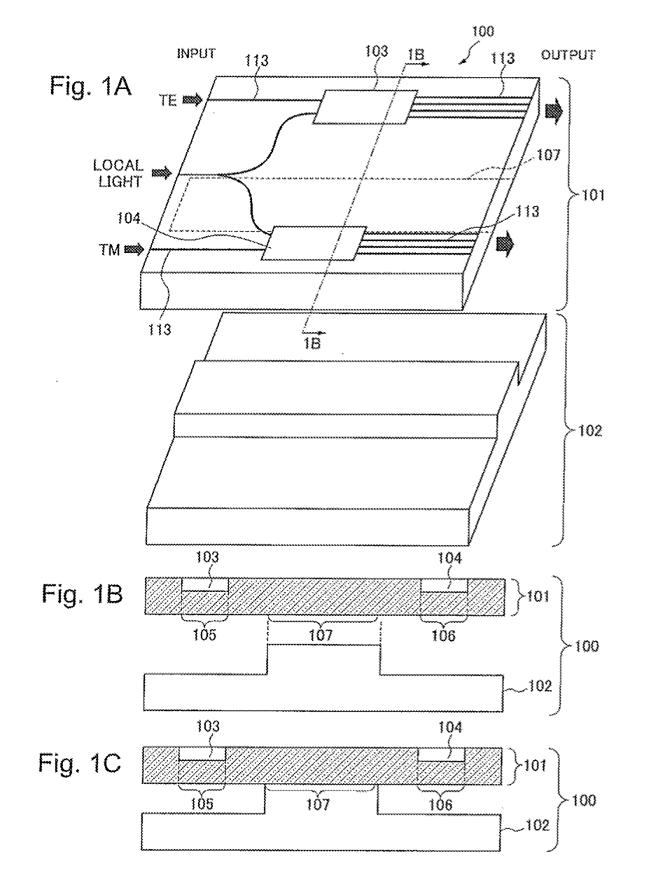

As shown in FIG. 1 (A), an optical module 100 of the present embodiment includes a substrate 101 and a carrier 102 on which the substrate 101 is mounted. A first interferometer 103, a second interferometer 104 and a waveguide 113 which is connected with these interferometers, are fabricated on the substrate 101.

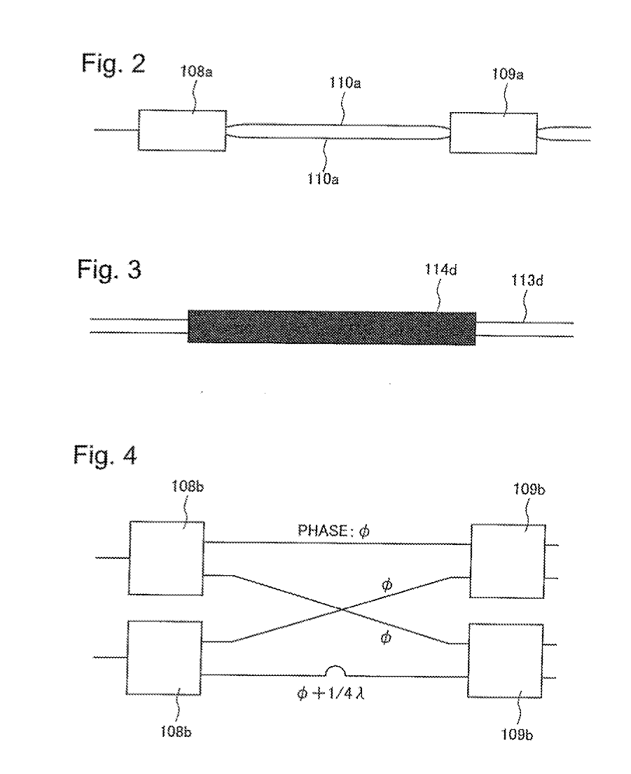

Further, a structure of the optical module 100 is described in detail by referring to FIG. 1B. FIG. 1B is the 1B-1B line cross section diagram of the optical module 100 which is shown in FIG. 1A. The carrier 102 is connected to a part area of a bottom surface of the substrate 101. Incidentally, in the specification, a joining area 107 is defined as a part area of the bottom surface of the substrate 101 to which the carrier 102 joins. In addition, in the specification, a first interferometer area 105 is defined as a part area of the bottom surface corresponding to the area on the substrate which the first interferometer 103 occupies. Further, in the specification, a second interferometer area 106 is defined as a part area of the bottom surface corresponding to an area on the substrate which the second interferometer 104 occupies. As shown in FIG. 2, the joining area 107 includes neither the first interferometer area 105 nor the second interferometer area 106. Therefore, as shown in FIG. 1, the optical module 100 includes the substrate 101 and the carrier 102 which is connected to the joining area 107 of the substrate 101, and neither the first interferometer area 105 nor the second interferometer area 106 are included in the joining area 107.

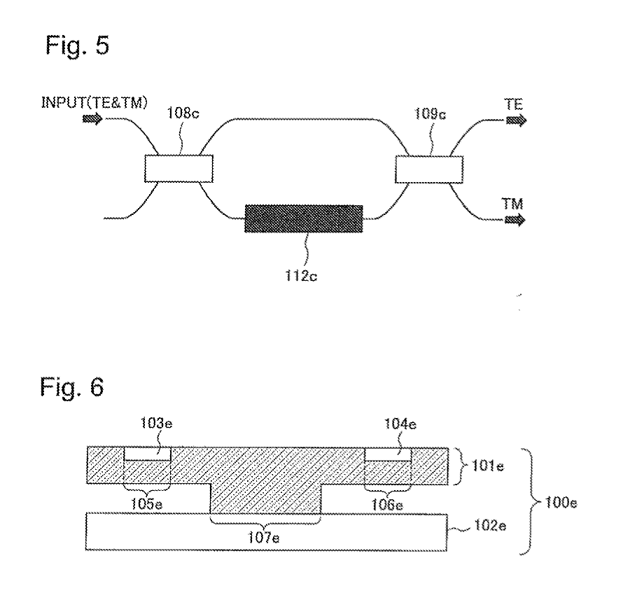

As the first interferometer 103 and the second interferometer 104, a hybrid interferometer which is shown in FIG. 4 can be employed. In addition, as the first interferometer 103 and the second interferometer 104, the MZI shown in FIG. 2 or the MMI shown in FIG. 3 can be employed. A MMI 114 is connected with a waveguide 113d. Further, it can use the PBS using the MZI as shown in FIG. 5.

The joining area 107 of the optical module 100 according to the embodiment includes neither the first interferometer area 105 nor the second interferometer area 106. That is, the carrier 102 is connected to areas of neither the first interferometer area 105 nor the second interferometer area 106. For this reason, because the stress which is affected by the carrier 102 is released at the first interferometer area 105 and at the second interferometer area 106, it can suppress the fluctuation of the refractive index and can keep the accuracy of interferometer at a high level. Further, the carrier 102 can be connected to areas of the substrate 101 excluding the first interferometer area 105 and the second interferometer area 106. For this reason, because the carrier 102 mounts the substrate 101, it can keep an enough area for joining the substrate 101 to the carrier 102 and can get enough mechanical strength as the entire optical module 100.

It is desirable that the carrier 102 has a projecting part. In this case, it is desirable that the projecting part is connected to the joining area 107 of the substrate 101.

In addition, as shown in FIG. 6, it is desirable that a bottom surface of a substrate 101e of an optical module 100e has the projecting part. In this case, it is also desirable that the projecting part is a joining area 107e which is connected to a carrier 102e. The substrate 101e has a first interferometer 103e and a second interferometer 104e. The joining area 107e includes neither a first interferometer area 105e nor a second interferometer area 106e.

In the above-mentioned descriptions, although a case is described in which the optical module 100 has two interferometers including the first interferometer 103 and the second interferometer 104, number of the interferometers is not limited to two. For example, the optical module may have no smaller than three interferometers or may have one interferometer.

The shape of the joining area 107 has no limitations. For example, as shown in FIG. 1, the joining area 107 can be an area between the first interferometer area and the second interferometer area. In the specification, it defines a type-I structure as a structure of the optical module 100 having the joining areas 107 with this kind of shape. The type-I structure is effective when a distance between the first interferometer 103 and the second interferometer 104 is long. In the type-I structure, it can reduce the stress added to the interferometers because the joining area 107 exists in one side of the interferometers.

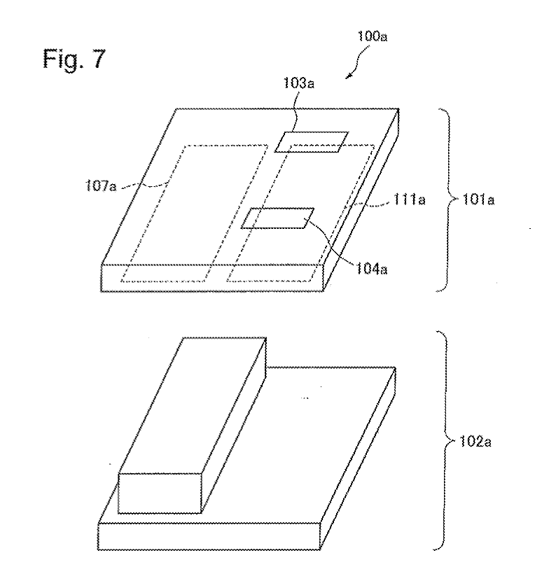

In addition, as shown in FIG. 7, a joining area 107a can be a first crosswise area located adjoining to a third interferometer area 111a which includes a first interferometer area corresponding to a first interferometer 103a, a second interferometer area corresponding to a second interferometer 104a and an area between the first interferometer area and the second interferometer area. In the specification, a cantilever structure means the structure of an optical module 100a including a substrates 101a having the joining areas 107a with this kind of shape and a carriers 102a on which the substrate 101a is mounted. The cantilever structure is useful when the interferometers of both the first interferometer 103a and the second interferometer 104a can be arranged at edges of the substrate. By adapting the cantilever structure, the stress added to the interferometers can be reduced because the joining area 107a exists in one side of the interferometers.

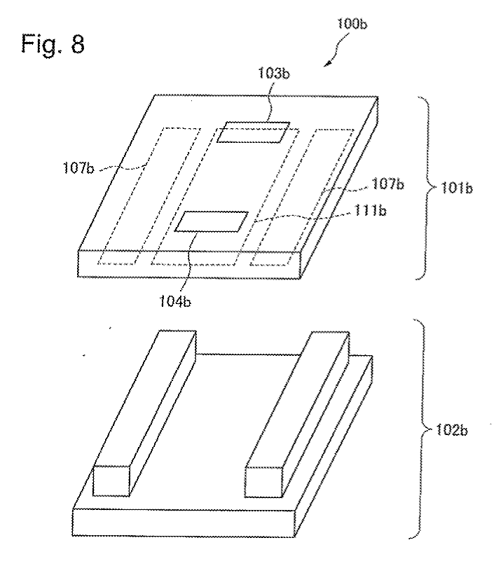

In addition, as shown in FIG. 8, a joining area 107b can be an area located at a left and right position to a third interferometer area 111b which includes a first interferometer area corresponding to a first interferometer 103b, a second interferometer area corresponding to a second interferometer 104b and an area between the first interferometer area and the second interferometer area. That is, the joining area 107b includes a first crosswise area which is located at an adjoining position of the third interferometer area 111b and a second crosswise area which is located at the opposite position to the first crosswise area across the third interferometer area 111b. In the specification, a type-II structure means the structure of an optical module 100b including a substrate 101b having the joining areas 107b with this kind of shape and a carrier 102b on which the substrate 101b is mounted. The type-II structure is useful when a distance between the first interferometer 103b and the second interferometer 104b is short. In addition, for the case of type-II structure, enough mechanical strength can be maintained because the joining area 107b is arranged so that it interposes the first interferometer 103b and the second interferometer 104b.

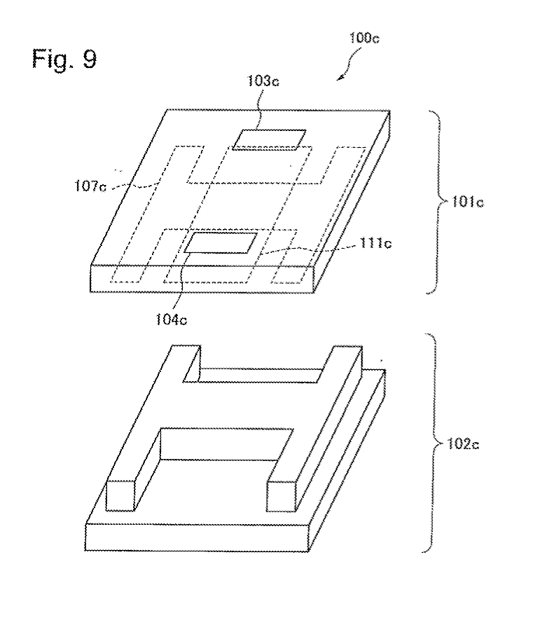

Further, as shown in FIG. 9, a joining area 107c may include an area between a first interferometer area corresponding to a first interferometer 103c and a second interferometer area corresponding to a second interferometer 104c, and an area located in the left and right position of a third interferometer area 111c which includes the first interferometer area, the second interferometer area and an area between these areas. In the specification, a type-H structure means the structure of an optical module 100c including a substrate 101c having the joining area 107c with such shape and a carriers 102c on which the substrate 101c is mounted. In the type-H structure, enough mechanical strength can be maintained because the joining area 107c is arranged so that it may surround the first interferometer 103c and the second interferometer 104c.

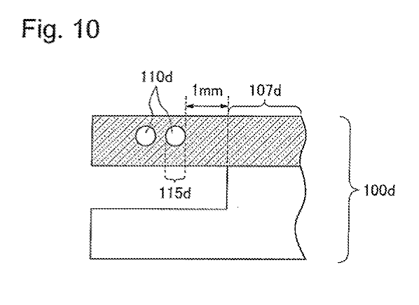

In addition, similar to an optical module 100d shown in FIG. 10, it is desirable that a joining area 107d is no smaller than 1 mm away from a part area 105d of the bottom surface corresponding to an area of a waveguide 110d, which composes the first interferometer, on the substrate. With the separation of no smaller than 1 mm of these, the accuracy of the interferometer can be kept more securely at a high level.

### Second Embodiment

Next, a manufacturing method of the optical module of the embodiment is described with reference to FIG. 1.

According to the manufacturing method of the optical module 100 of the embodiment, the carrier 102 which mounts the substrate 101 is connected to the joining area 107 which is a part area of the bottom surface of the substrate 101 which mounts the interferometers and does not include other part area of the bottom surface corresponding to the areas which the interferometers occupy on the substrate 101. As the result, the optical module 100 can be fabricated according to the first embodiment.

For example, the joining area 107 can be formed by fixing a metallic film at the bottom surface of the substrate 101 and patterning it. By patterning the metallic film and assigning a part having the metallic films as the joining area 107 as well as assigning a part not having the metallic films as remaining areas, the carrier 102 can be easily connected to the joining area 107 using solder.

### DETAILED DESCRIPTION OF THE PREFERRED EMBODIMENTS

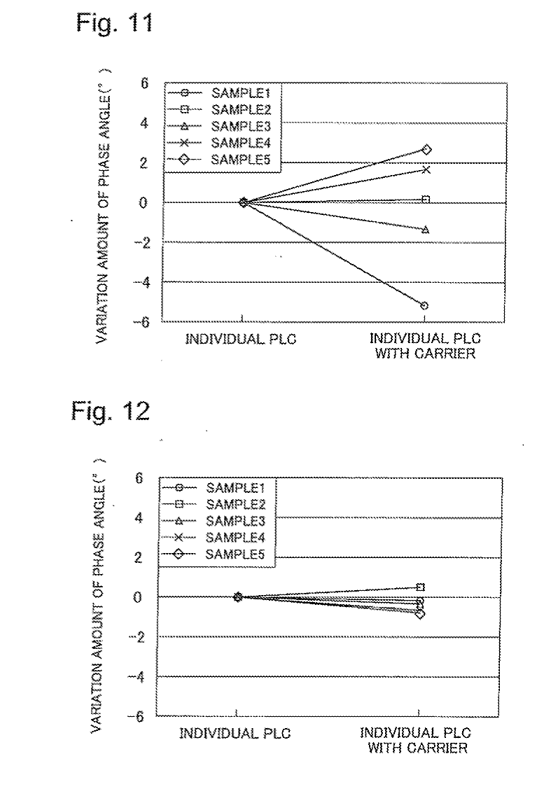

Next, a detailed description of a preferred embodiment of the present invention is described. In the detailed description of the preferred embodiment, for a case of substrate of type-H structure, a difference of phase angle (variation amount of phase angles) for a substrate element (individual PLC) having the hybrid interferometers and a pattern of the metallic film formed at bottom surface of the substrate, and that for an optical module (individual PLC with carrier) by soldering the substrate with the carrier having the projecting part, is surveyed. In addition, as an example of comparison, a difference of phase angle (variation amount of phase angles) for the substrate element (individual PLC) having the hybrid interferometers and the metallic film formed at whole the bottom surface of the substrate, and that for the optical module (individual PLC with carrier) by soldering the substrate with the carrier having the projecting part, is surveyed. The results of the example of comparison are shown in FIG. 11. The results of the detailed description of the preferred embodiment of the present invention are shown in FIG. 12.

As shown in FIG. 11, the detected maximum variation amount of the phase angle is about at most 5 degrees in the example of comparison. On the other hand, as shown in FIG. 12, in the detailed description of the preferred embodiment of the present invention, it could suppress the variation amount of the phase angle at no more than one degree in all of five samples.

The whole or part of the exemplary embodiments disclosed above can be described as, but not limited to, the following supplementary notes.

(Supplementary note 1) An optical module comprising:

a substrate comprising interferometers; and

a carrier which is connected to a joining area which is a part area of a bottom surface of said substrate, wherein

said bottom surface area corresponding to an area on said substrate which said interferometer occupies is not included in said joining area.

(Supplementary note 2) The optical module according to Supplementary note 1, wherein

said substrate comprises no smaller than two interferometers including a first interferometer and a second interferometer.

(Supplementary note 3) The optical module according to Supplementary note 1 or 2, wherein

said joining area and said bottom surface area corresponding to an area occupied by a waveguide of which said interferometer is composed on said substrate are separated by no smaller than 1 mm.

(Supplementary note 4) The optical module according to Supplementary note 2 or 3, wherein said joining area comprises a first crosswise area which locates adjoining to:

a first interferometer area that is an area of said bottom surface corresponding to an area on said substrate which said first interferometer occupies;

a second interferometer area which is another area of said bottom surface corresponding to an area on said substrate which said second interferometer occupies; and

a third interferometer area including an area of said bottom surface between said first interferometer area and said second interferometer area.

(Supplementary note 5) The optical module according to Supplementary note 4, wherein said joining area comprises a second crosswise area which is located at:

an opposite position to said first crosswise area across said third interferometer area.

(Supplementary note 6) The optical module according to any one of Supplementary notes 2 to 5, wherein said joining area comprises area between:

a first interferometer area which is an area of said bottom surface corresponding to an area on said substrate which said first optical interferometer occupies; and

a second interferometer area which is another area of said bottom surface corresponding to an area on said substrate which said second optical interferometer occupies.

(Supplementary note 7) The optical module according to any one of Supplementary notes 1 to 6, wherein

said interferometer is a hybrid interferometer.

(Supplementary note 8) The optical module according to any one of Supplementary notes 1 to 7, wherein

a first projecting part is located at a surface of said carrier, and

said joining area is connected to said first projecting part.

(Supplementary note 9) The optical module according to Supplementary note 1, wherein

a second projecting part is located at a bottom surface of said substrate, and

said joining area is said second projecting part.

(Supplementary note 10) The optical module according to Supplementary note 1, wherein
said substrate is connected to said carrier using solder.
   (Supplementary note 11) A manufacturing method of the optical module, comprising the steps of:

forming a joining area; and

connecting a carrier which mounts said substrate to said joining area which is a part area of a bottom surface of a substrate having the interferometers and does not include other part area of said bottom surface which is corresponding to an area which said interferometer occupies on said substrate.

(Supplementary note 12) The manufacturing method of the optical module according to Supplementary note 11, wherein

said joining area is formed by patterning a metallic film fixed in the bottom surface of said substrate, and

said carrier joins to said joining area by solder so that a part having said metallic films serves as said joining area.

An exemplary advantage according to the invention is that, it can keep the accuracy of interferometers in a high level without causing any degradation of mechanical strength of the optical module.

The previous descriptions of the embodiments are provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. An optical module comprising:
a substrate comprising interferometers; and
a carrier which is connected to a joining area which is a part area of a bottom surface of said substrate, wherein
said bottom surface area corresponding to an area on said substrate which said interferometer occupies is not included in said joining area.

2. The optical module according to claim 1, wherein
said substrate comprises no smaller than two interferometers including a first interferometer and a second interferometer.

3. The optical module according to claim 1, wherein
said joining area and said bottom surface area corresponding to an area occupied by a waveguide of which said interferometer is composed on said substrate are separated by no smaller than 1 mm.

4. The optical module according to claim 2, wherein said joining area comprises a first crosswise area which locates adjoining to:
a first interferometer area that is an area of said bottom surface corresponding to an area on said substrate which said first interferometer occupies;
a second interferometer area which is another area of said bottom surface corresponding to an area on said substrate which said second interferometer occupies; and
a third interferometer area including an area of said bottom surface between said first interferometer area and said second interferometer area.

5. The optical module according to claim 4, wherein said joining area comprises a second crosswise area which is located at:
an opposite position to said first crosswise area across said third interferometer area.

6. The optical module according to claim 2, wherein said joining area comprises area between:
a first interferometer area which is an area of said bottom surface corresponding to an area on said substrate which said first optical interferometer occupies; and
a second interferometer area which is another area of said bottom surface corresponding to an area on said substrate which said second optical interferometer occupies.

7. The optical module according to claim 1, wherein
said interferometer is a hybrid interferometer.

8. The optical module according to claim 1, wherein
a first projecting part is located at a surface of said carrier, and
said joining area is connected to said first projecting part.

9. The optical module according to claim 1, wherein
a second projecting part is located at a bottom surface of said substrate, and
said joining area is said second projecting part.

10. The optical module according to claim 1, wherein
said substrate is connected to said carrier using solder.

11. A manufacturing method of the optical module, comprising the steps of:
forming a joining area; and
connecting a carrier which mounts said substrate to said joining area which is a part area of a bottom surface of a substrate having the interferometers and does not include other part area of said bottom surface which is corresponding to an area which said interferometer occupies on said substrate.

12. The manufacturing method of the optical module according to claim 11, wherein
said joining area is formed by patterning a metallic film fixed in the bottom surface of said substrate, and
said carrier joins to said joining area by solder so that a part having said metallic films serves as said joining area.
